(19) United States
(12) Patent Application Publication
(10) Pub. No.: US 2018/0306236 A1
(43) Pub. Date: Oct. 25, 2018

(54) SELF-LOCKING SLIDING RAIL ASSEMBLY

(71) Applicant: Chia-Ming Liu, Douliou City (TW)

(72) Inventor: Chia-Ming Liu, Douliou City (TW)

(21) Appl. No.: 15/668,916

(22) Filed: Aug. 4, 2017

(30) Foreign Application Priority Data
Apr. 19, 2017 (CN) 201720412680.7

(51) Int. Cl. F16C 17/10

(52) U.S. Cl. CPC F16C 17/10; A47B 88/477

(57) ABSTRACT

A self-locking sliding rail assembly includes a stationary outer rail, a stationary seat, a sliding seat, an engaging member, a rebounding unit, a buffering unit, a sliding inner rail, a positioning member and a pulling member. The buffering unit buffers movements of the sliding seat relative to the stationary seat, and has a cylinder that contains a buffer liquid and that is connected to the stationary seat, and a buffering piston rod that is disposed in the cylinder and connected to the sliding seat. The cylinder has a transparent observation window for a user to view and examine the buffer fluid contained in the cylinder. The sliding seat is movable relative to the stationary seat between a locking position and an engaging position.

### CROSS-REFERENCE TO RELATED APPLICATION

This application claims priority of Chinese Utility Model Patent Application No. 201720412680.7, filed on Apr. 19, 2017.

### FIELD

The disclosure relates to a self-locking sliding rail assembly, and more particularly to a self-locking sliding rail assembly with a built-in transparent observation window.

### BACKGROUND

Referring to FIG. 1, a conventional self-locking sliding rail assembly 1 includes a stationary outer rail 11, a stationary seat 12, a sliding seat 13, an engaging member 14, a rebounding unit 15, a buffering unit 16, a sliding inner rail 17, a positioning member 18 and a pulling member 19. The stationary seat 12 is mounted to the stationary outer rail 11. The sliding seat 13 is slidably mounted to the stationary outer rail 11. The engaging member 14 is swingably mounted to the sliding seat 13. The rebounding unit 15 is disposed between the sliding seat 13 and the stationary seat 12 to urge the sliding unit 13 to move toward the stationary seat 12. The buffering unit 16 is connected between the sliding seat 13 and the stationary seat 12, and has a cylinder 161 connected to the stationary seat 12 and a buffering piston rod 162 disposed in the cylinder 161 and connected to the sliding seat 13. The sliding inner rail 17 is slidably mounted to the stationary outer rail 11. The positioning member 18 is disposed on the stationary outer rail 11. The pulling member 19 is disposed on an end of the sliding inner rail 17 near the stationary seat 12. The sliding seat 13 is movable relative to the stationary seat 12 between a locking position, where the sliding seat 13 is spaced apart from the stationary seat 12 and the engaging member 14 is engaged with the positioning member 18, and an engaging position, where the sliding seat 13 is moved close to the stationary seat 12 and the engaging member 14 is engaged with the pulling member 19.

During the manufacturing process of the buffering unit 16, the cylinder 161 may unintentionally contain too much air that can easily undermine the buffering effect of the buffering unit 16. However, there is no way to determine the amount of air present in the buffering unit 16 until after its installation. Then, physical testing of the buffering effect of the buffering unit 16 has to be conducted, which complicates the quality control process of the conventional self-locking sliding rail assembly 1.

### SUMMARY

Therefore, an object of the disclosure is to provide a self-locking sliding rail assembly that can alleviate at least one of the drawbacks of the prior art.

According to the disclosure, a self-locking sliding rail assembly includes a stationary outer rail, a stationary seat, a sliding seat, a sliding inner rail, an engaging member, a positioning member, a pulling member, a rebounding unit and a buffering unit.

The stationary seat is mounted to the stationary outer rail.

The sliding seat is slidably mounted to the stationary outer rail.

The sliding inner rail is slidably mounted to the stationary outer rail.

The engaging member is swingably mounted to the sliding seat.

The positioning member is disposed on the stationary outer rail and detachably engageable with the engaging member.

The pulling member is disposed on the sliding inner rail and detachably engageable with the engaging member.

The rebounding unit is disposed between the sliding seat and the stationary seat to urge the sliding seat to move toward the stationary seat.

The buffering unit is connected between the sliding seat and the stationary seat to buffer movements of the sliding seat relative to the stationary seat. The buffering unit has a cylinder containing a buffer fluid, and a buffering piston rod disposed in the cylinder and connected to the sliding seat. The cylinder has a transparent observation window for a user to view and examine the buffer fluid contained in the cylinder.

The sliding seat is movable relative to the stationary seat between a locking position, where the sliding seat is spaced apart from the stationary seat and the engaging member is engaged with the positioning member, and an engaging position, where the sliding seat is moved close to the stationary seat and the engaging member is engaged with the pulling member.

### BRIEF DESCRIPTION OF THE DRAWINGS

Other features and advantages of the disclosure will become apparent in the following detailed description of the embodiment with reference to the accompanying drawings, of which:

FIG. 1 is a partly exploded view illustrating a conventional self-locking sliding rail assembly;

FIG. 2 is a partly exploded perspective view illustrating an embodiment of a self-locking sliding rail assembly according to the disclosure; and

FIG. 3 is a fragmentarily front view illustrating a sliding seat of the self-locking sliding rail assembly of FIG. 2 in a locking position;

FIGS. 4 to 6 are fragmentarily schematic views illustrating movement of the sliding seat of the self-locking sliding rail assembly of FIG. 2 from the locking position to an engaging position; and

FIG. 7 is fragmentarily schematic view illustrating movement of the sliding seat of the self-locking sliding rail assembly of the embodiment from the engaging position back to the locking position.

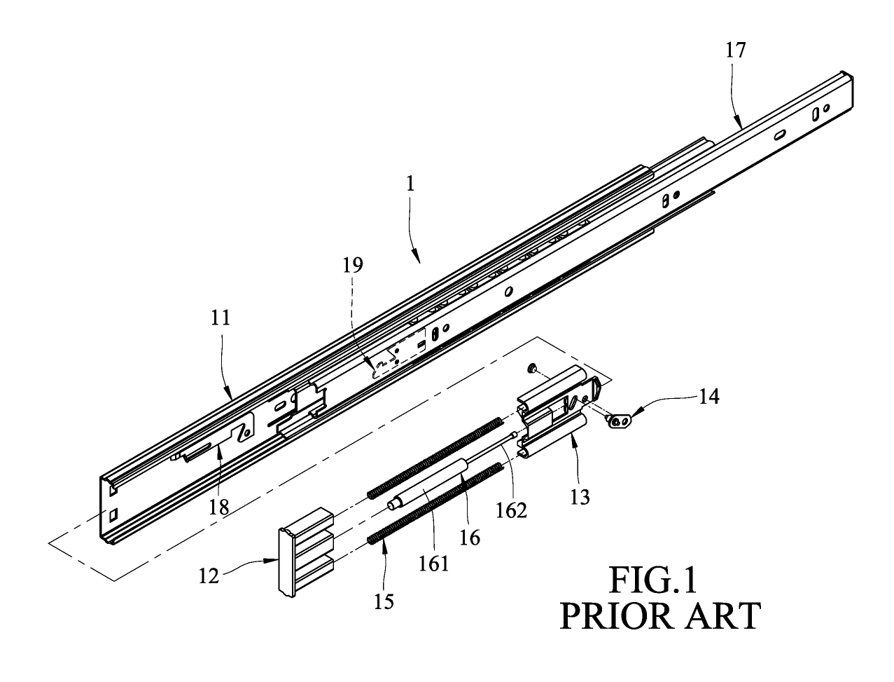

### DETAILED DESCRIPTION

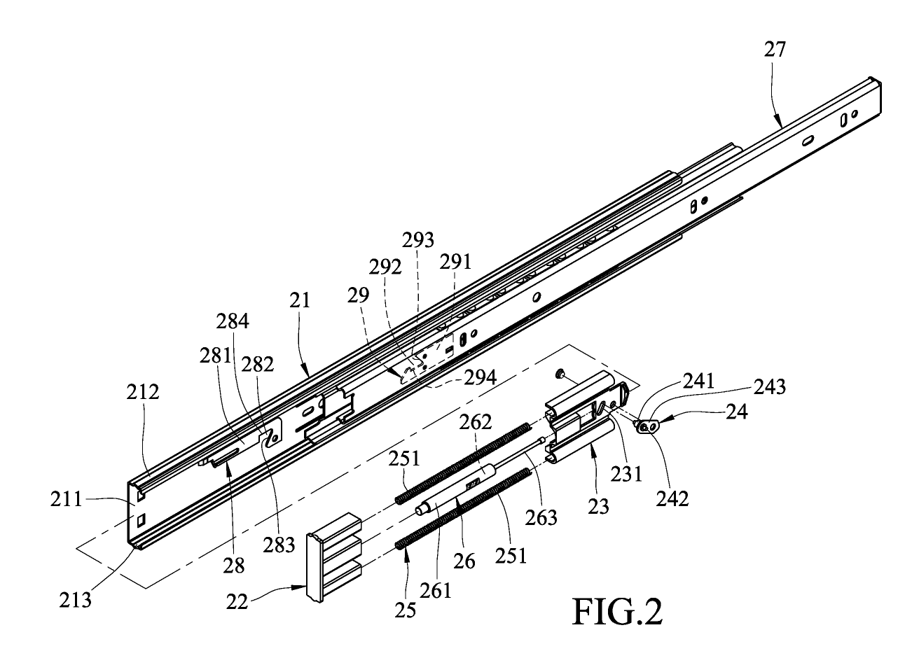

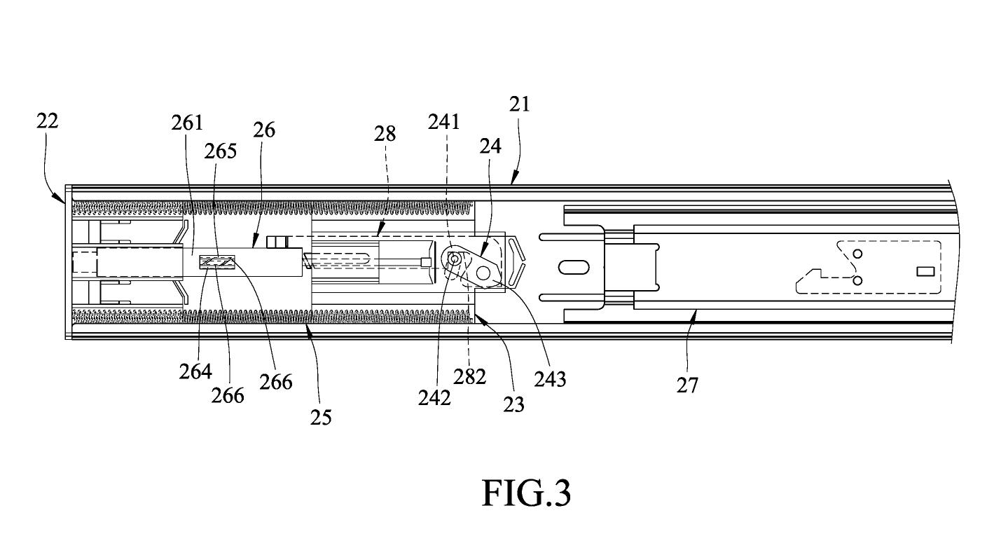

Referring to FIGS. 2 to 3, an embodiment of a self-locking sliding rail assembly according to the disclosure includes a stationary outer rail 21, a stationary seat 22, a sliding seat 23, an engaging member 24, a rebounding unit 25, a buffering unit 26, a sliding inner rail 27, a positioning member 28 and a pulling member 29.

The stationary outer rail 21 includes a longitudinally extending base wall 211 and first and second longitudinally extending side walls 212, 213 respectively connected to two opposite sides of the longitudinally extending base wall 211. The longitudinally extending base wall 211 and the first and second longitudinally extending side walls 212, 213 cooperatively define a space for receiving the stationary seat 22, the sliding seat 23, the sliding inner rail 27, the engaging member 24 and the rebounding unit 25.

The stationary seat 22 is mounted to the stationary outer rail 21. The sliding seat 23 is slidably mounted to the stationary outer rail 21 and formed with a through hole 231.

The engaging member 24 is swingably mounted to the sliding seat 23, and includes a base plate 243, a positioning protrusion 241 that protrudes from the base plate 243 and that passes through the through hole 231, and a pulling protrusion 242 that protrudes from the base plate 243 oppositely of the positioning protrusion 241.

The rebounding unit 25 is disposed between the sliding seat 23 and the stationary seat 22 to urge the sliding seat 23 to move toward the stationary seat 22. The rebounding unit 25 includes two resilient members 251 respectively connected between the sliding seat 23 and the stationary seat 22 at two opposite sides of the buffering unit 26. In this embodiment, the two resilient members 251 are exemplified by springs.

The buffering unit 26 is connected between the sliding seat 23 and stationary seat 22, and has a cylinder 261 that is connected to the stationary seat 22, a chamber 262 that is formed inside the cylinder 261, a buffering piston rod 263 that is disposed in the cylinder 261 and connected to the sliding seat 23, and a buffer fluid 264 that is stored within the chamber 262. The cylinder 261 has a transparent observation window 265 for a user to view and examine the buffer fluid 264 in the chamber 262. In addition, the observation window 265 of the cylinder 261 has an outer surface marked with a pair of reference lines 266 that are parallel to an axis of the cylinder 261. In this embodiment, the cylinder 261 is a hydraulic buffer cylinder. The cylinder 261 may be made from a transparent material.

The sliding inner rail 27 is slidably mounted to the stationary outer rail 21.

The positioning member 28 is disposed on the stationary outer rail 21 and detachably engageable with the engaging member 24. The positioning member 28 includes a positioning body 281 formed with a retaining groove 282 having a downward open end facing the second longitudinally extending side wall 213 of the stationary outer rail 21, a retaining groove upper edge 284 bounding the retaining groove 282 oppositely of the downward open end, and an oblique side edge 283 extending downwardly and obliquely from the retaining groove upper edge 284 toward the stationary seat 22 and the second longitudinally extending side wall 213.

The pulling member 29 is disposed on the sliding inner rail 27 and detachably engageable with the engaging member 24. The pulling member 29 includes a pulling body 291 formed with an engaging groove 292 having a upward open end facing the first longitudinally extending side wall 212 of the stationary outer rail 21, an engaging groove bottom edge 294 bounding the engaging groove 292 oppositely of the upward open end, and an oblique side edge 293 extending upwardly and obliquely from the engaging groove bottom edge 294 toward the stationary seat 22 and the first longitudinally extending side wall 212.

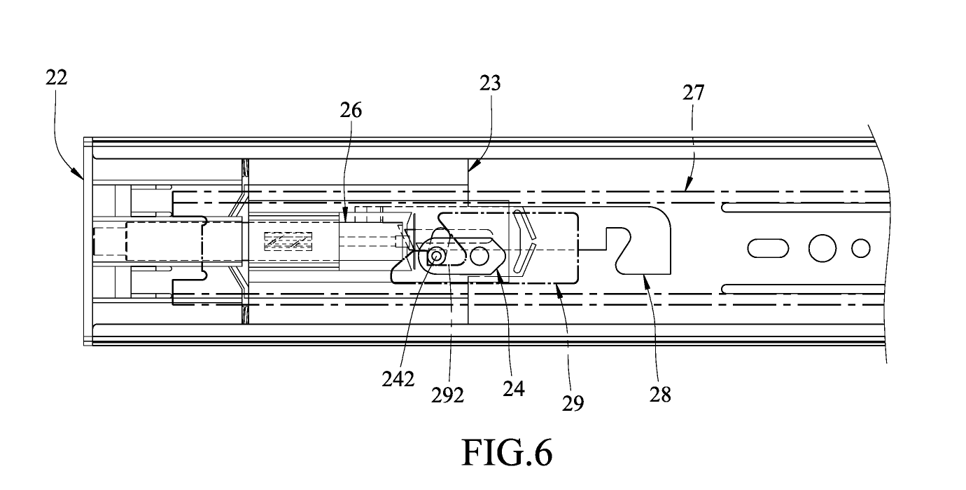

Referring to FIGS. 3 and 6, the sliding seat 23 is movable relative to the stationary seat 22 between a locking position (see FIGS. 3), where the sliding seat 23 is spaced apart from the stationary seat 22 and the positioning protrusion 241 of the engaging member 24 is engaged in the retaining groove 282 of the positioning member 28, and an engaging position (see FIG. 6), where the sliding seat 23 is moved close to the stationary seat 22 and the pulling protrusion 242 of the engaging member 24 is engaged in the engaging groove 292 of the pulling member 29.

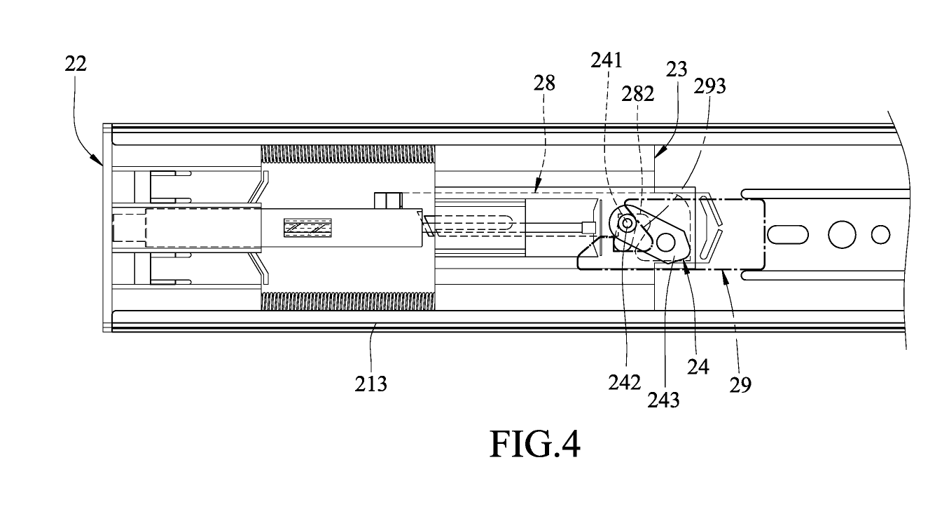

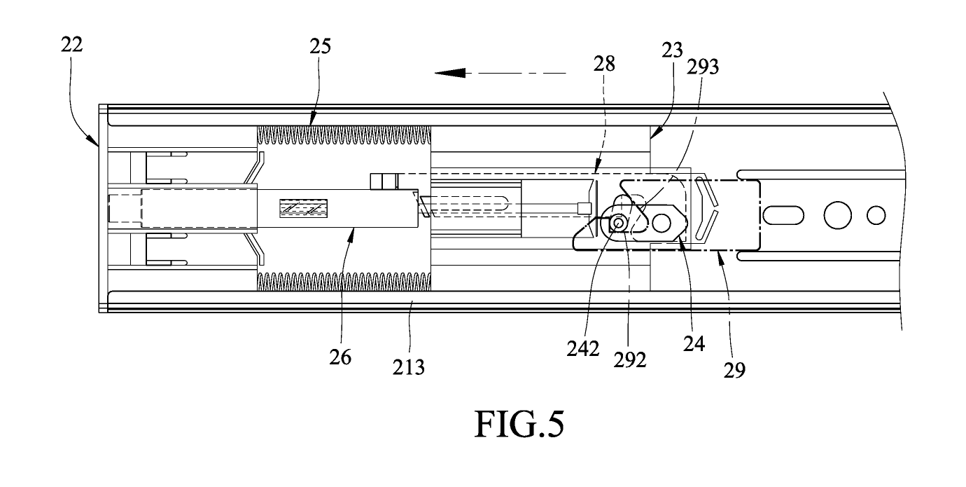

Referring to FIGS. 3 and 4, when the sliding seat 23 is in the locking position and the sliding inner rail 27 is pushed inward by an external force to move toward the stationary seat 22, the oblique side edge 293 of the pulling member 29 pushes the pulling protrusion 242 to slide along the through hole 231 and to swing the engaging member 24 toward the second longitudinally extending side wall 213 (see FIGS. 5) so that the positioning protrusion 241 disengages from the retaining groove 282, and the pulling protrusion 242 is guided by the oblique side edge 293 of the pulling member 29 to slide into the engaging groove 292. A returning force of the rebounding unit 25 causes the sliding seat 23 to slide toward the stationary seat 22 to reach the engaging position (see FIGS. 6). While getting into the engaging position, the sliding inner rail 27 is driven by the pulling protrusion 242 hooked onto the pulling member 29 so that the sliding seat 23 brings the sliding inner rail 27 to slide toward the stationary seat 22. The buffering piston rod 263 of the buffering unit 26, through resistance provided by the buffer fluid 264 inside the chamber 262, buffers movements of the sliding seat 23 relative to the stationary seat 22 to minimize collision damage between the stationary seat 22 and the sliding seat 23.

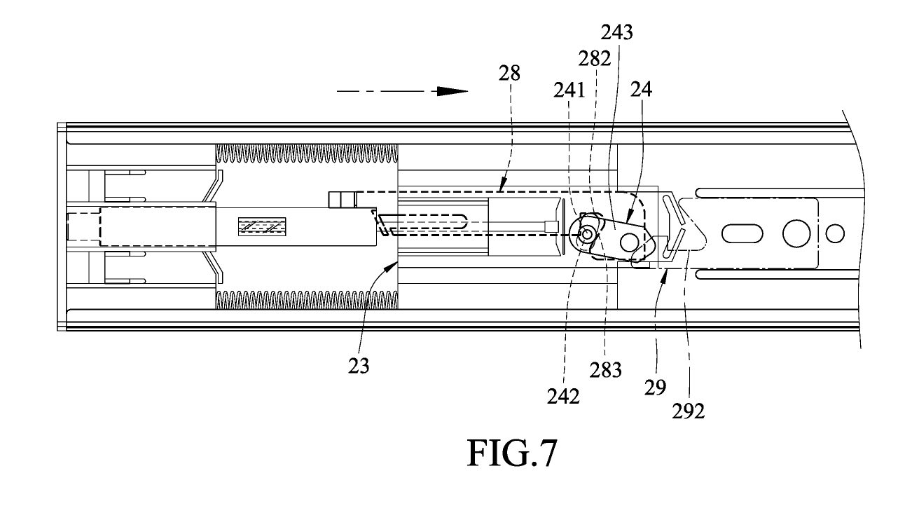

Referring to FIGS. 6 and 7, when the sliding inner rail 27 is pulled outward by an external force to move away from the stationary seat 22, the pulling protrusion 242 that is hooked onto the pulling member 29 pulls the sliding seat 23 away from the stationary seat 22 until the sliding seat 23 returns to the locking position, in which the positioning protrusion 241 of the engaging member 24 slides along the oblique side edge 283 of the positioning member 28 into the retaining groove 282 and the pulling protrusion 242 is disengaged from the engaging groove 292.

Referring to FIGS. 2 and 3, the user may examine an air content of the chamber 262 through the observation window 265 before the buffering unit 26 is installed. To determine the air-containing status, the user may hold the cylinder 261 in such way that the observation window 265 faces upward, in which air bubbles will float toward the observation window 265 for measurement. If the width of all the air bubbles at the top exceeds the distance between the two reference lines 266, it indicates an overabundance of the air inside the chamber 262 which could hinder the buffering action of the buffering unit 26. Instead of testing the buffering unit 26 physically after installation, the implementation of the observation window 265 at the buffering unit 26 simplify the quality control process, reducing overall production time.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been de scribed in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A self-locking sliding rail assembly, comprising a stationary outer rail;
a stationary seat mounted to said stationary outer rail;
a sliding seat slidably mounted to said stationary outer rail;
a sliding inner rail slidably mounted to said stationary outer rail;
an engaging member swingably mounted to said sliding seat;
a positioning member disposed on said stationary outer rail and detachably engageable with said engaging member;
a pulling member disposed on said sliding inner rail and detachably engageable with said engaging member;
a rebounding unit disposed between said sliding seat and said stationary seat to urge said sliding seat to move toward said stationary seat; and
a buffering unit connected between said sliding seat and said stationary seat to buffer movements of said sliding seat relative to said stationary seat, said buffering unit having a cylinder containing a buffer fluid, and a buffering piston rod disposed in said cylinder and connected to said sliding seat, said cylinder having a transparent observation window for a user to view and examine said buffer fluid contained in said cylinder,
wherein said sliding seat is movable relative to said stationary seat between a locking position, where said sliding seat is spaced apart from said stationary sea) and said engaging member is engaged with said positioning member, and an engaging position, where said sliding seat is moved close to said stationary seat and said engaging member is engaged with said pulling member.

2. The self-locking sliding rail assembly of claim 1, wherein said stationary outer rail includes a longitudinally extending base wall and first and second longitudinally extending side walls respectively connected to two opposite sides of said longitudinally extending base wall, said base wall and said first and second longitudinally extending side walls cooperatively defining a space for receiving said stationary seat, said sliding seat, said sliding inner rail, said engaging member and said rebounding unit, said buffering unit, said positioning member and said pulling member.

3. The sliding self-locking rail assembly of claim 2, wherein
said sliding seat is formed with a through hole;
said engaging member includes a base plate, a positioning protrusion protruding from said base plate and passing through said through hole, and a pulling protrusion protruding from said base plate oppositely of said positioning protrusion;
said rebounding unit includes two resilient members respectively connected between said sliding seat and said stationary seat at two opposite sides of said cylinder;
said positioning member includes a positioning body formed with a retaining groove having a downward open end facing said second longitudinally extending side wall of said stationary outer rail, a retaining groove upper edge bounding said retaining groove oppositely of said downward open end, and an oblique side edge extending downwardly and obliquely from said retaining groove upper edge toward said stationary seat and said second longitudinally extending side wall;
said pulling member includes a pulling body formed with an engaging groove having a upward open end facing said first longitudinally extending side wall of said stationary outer rail, an engaging groove bottom edge bounding said engaging groove oppositely of said upward open end, and an oblique side edge extending upwardly and obliquely from said engaging groove bottom edge toward said stationary seat and said first longitudinally extending side wall; and
wherein, when said sliding seat is in said locking position, said positioning protrusion is engaged in said retaining groove,
wherein, when said sliding inner rail is pushed inward by an external force to move toward said stationary seat, said oblique side edge of said pulling member pushes said pulling protrusion to slide along said through hole and to swing said engaging member so that: said positioning protrusion disengages from said retaining groove; said pulling protrusion is guided by said oblique side edge of said pulling member to slide into said engaging groove; a returning force of said rebounding unit causes said sliding seat to slide toward said stationary seat; and said sliding seat brings said sliding inner rail to slide toward said stationary seat,
wherein, when said sliding inner rail is pulled outward by an external force to move away from said stationary seat, said pulling protrusion that is hooked onto said pulling member pulls said sliding seat away from said stationary seat until said positioning protrusion slides along said oblique side edge of of said positioning member into said retaining groove and until said pulling protrusion is disengaged from said engaging groove.

4. The self-locking sliding rail assembly of claim 1, wherein said cylinder of said buffering unit is made from a transparent material.

5. The self-locking sliding rail assembly of claim 3, wherein said observation window of said cylinder has an outer surface marked with a pair of reference lines that are parallel to an axis of said cylinder.
